(19) United States
(12) Patent Application Publication
(10) Pub. No.: US 2015/0083793 A1
(43) Pub. Date: Mar. 26, 2015

(54) BrandScanned

(71) Applicant: Vince Edward Coyner, Cumming, GA (US)

(72) Inventor: Vince Edward Coyner, Cumming, GA (US)

(21) Appl. No.: 13/987,013

(22) Filed: Sep. 23, 2013

(51) Int. Cl. G06Q 90/00

(52) U.S. Cl. CPC G06Q 90/00
USPC 235/375

(57) ABSTRACT

BrandScanned is based upon a unique code placed in or on the packaging of every single participating product. An example would be on the inside of a cereal box, inside of a candy bar wrapper, inside the top of a peanut butter jar.

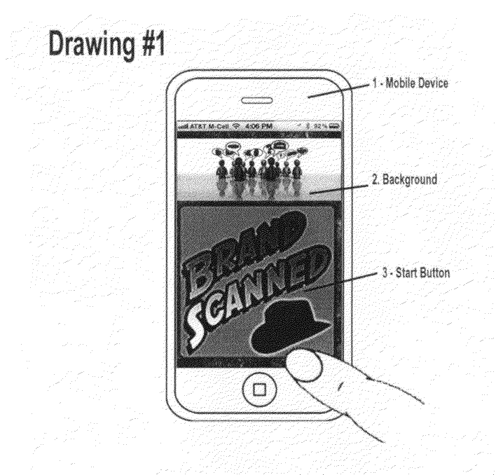

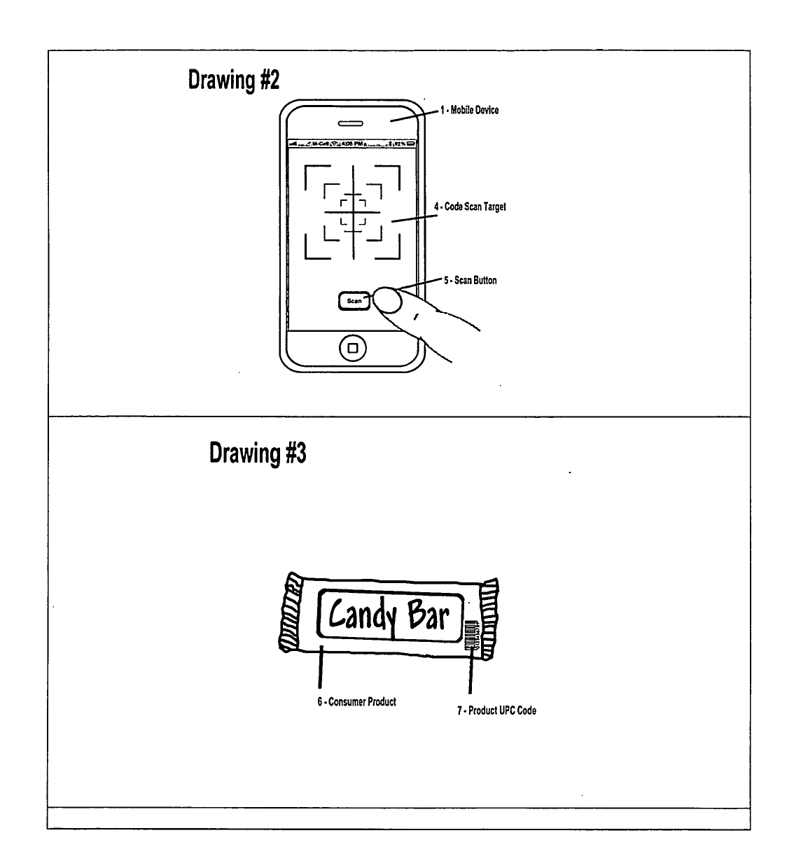

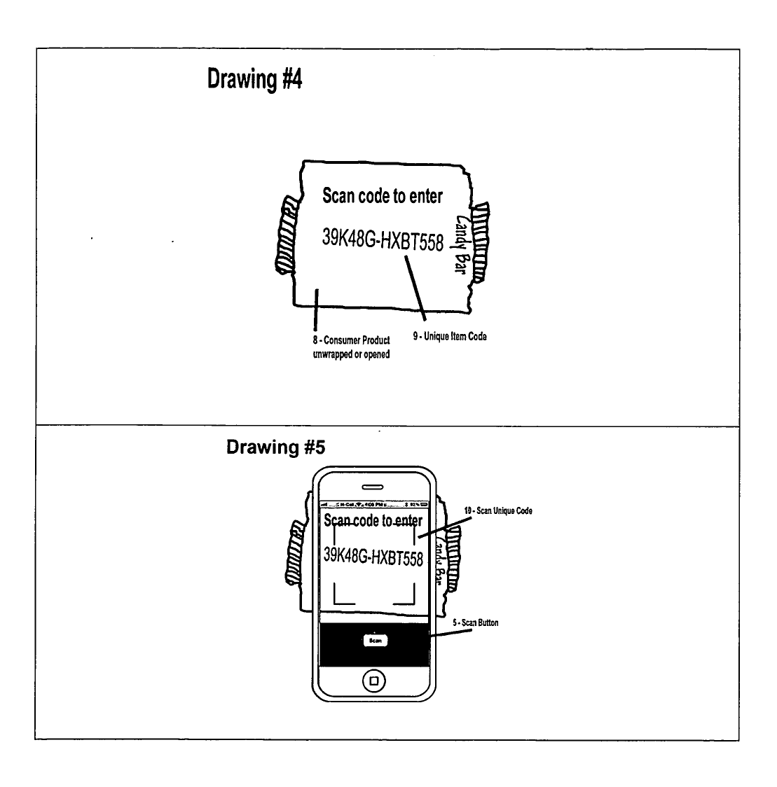

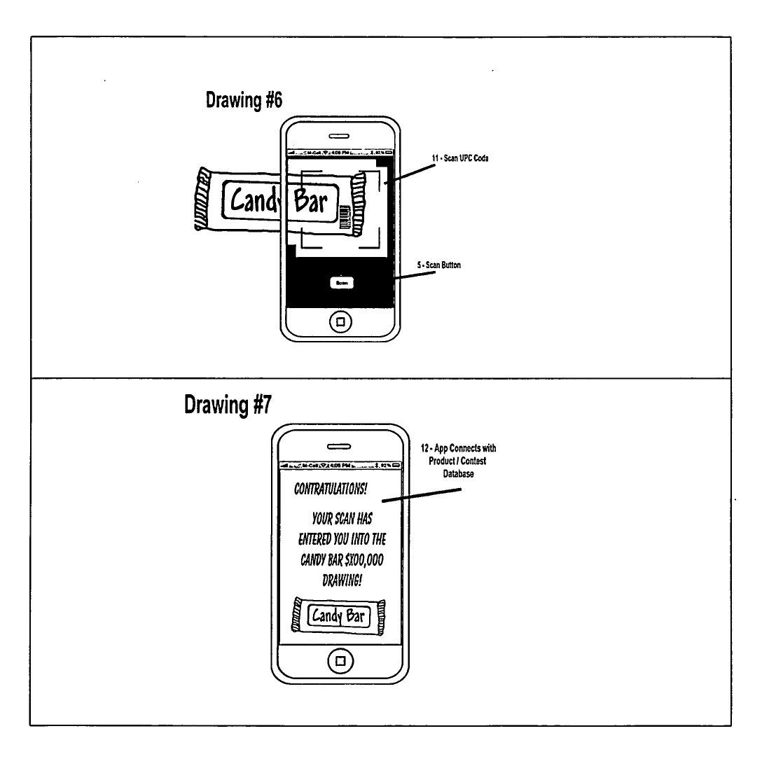

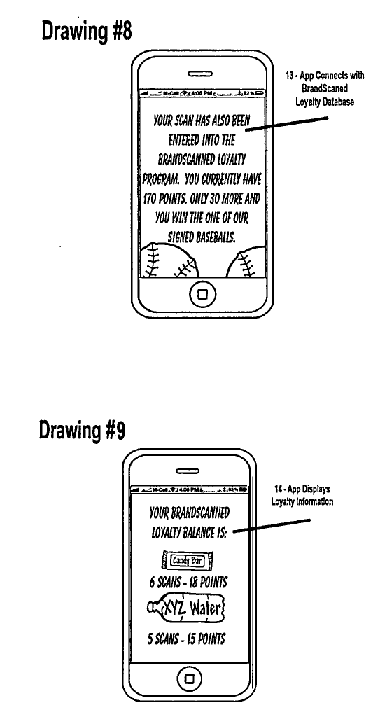

The unique code is scanned by the consumer using the BrandScanned mobile app. That scan tells the BrandScanned database exactly which product was scanned, who scanned it and when and perhaps other data that users wish to share. That data simultaneously communicates with the customer's BrandScanned account and adds points to their account. BrandScanned uses the scans of products to drive loyalty points in the BrandScanned community which can result in prizes from manufacturers and or entries into various BrandScanned operated sweepstakes.

The BrandScanned app is brand agnostic in that any manufacturer may participate with BrandScanned and make their products available to the BrandScanned member base.

### CROSS REFERENCES TO RELATED APPLICATIONS

This application claims the benefit of Applicants' prior provisional application, No. [61/690,657], filed on Jul. 2, 2012.

### FIELD OF INVENTION

The technology relates to the general field of social media software, consumer product advertising, mobile computing and data analysis.

### BACKGROUND

BrandScanned is a system that allows marketers and manufacturers of consumer products—such as candy bars, laundry detergent, frozen dinners, etc.—to utilize a unique code for each individual product (or packages of products) which can be scanned by the consumer/end user with their mobile device or other scanning device. This scan is done via the BrandScanned app that is downloaded into their mobile device, or may also be pre loaded. In scanning the unique code inside of each package, users register their use of that product with BrandScanned (where they have already created an account or will be prompted to do so) and they may in turn share that usage with friends via social networks. Users can earn prizes, points or other benefits which potentially could be exchanged for products and services.

Each individual product or package of products will have a unique code that will be printed on it somewhere, often on the inside of the packaging where it is typically accessible only after the product has been purchased and opened.

Manufacturers may have access to the BrandScanned member data in both aggregate and individual terms. Manufacturers will have the ability to utilize the BrandScanned platform to communicate directly and or indirectly with BrandScanned members and users in order to provide them with promotional offers, rewards or to solicit feedback on products members have either used or intend to use. Manufacturers may use BrandScanned members as a focus group for the purposes of garnering marketing insights.

### DRAWINGS

### Brief Description of the Drawings

Drawing #1 shows a mobile device with the BrandScanned start button.

Drawing #2 shows the target that the user will point at the code to be scanned.

Drawing #3 shows an image of a consumer product with a common UPC code on it.

Drawing #4 shows the wrapper of the consumer product with the unique code printed on the inside of it. This code can come from the BrandScanned database or a marketer can choose to use their own unique code.

Drawing #5 shows the user targeting the unique code for scanning.

Drawing #6 shows the user targeting the UPC code for scanning.

Drawing #7 shows the confirmation message the user receives when they scan the unique code, telling them they have been entered into the manufacturer's contest or sweepstakes.

Drawing #8 shows the confirmation message the user receives when they scan the unique code, telling them their scan has been added to their BrandScanned loyalty program.

Drawing #9 shows the app displaying loyalty account information.

What is claimed:

1. (canceled)

2. (canceled)

3. (canceled)

4. (canceled)

5. (canceled)

6. The scanning of BrandScanned code scans via a mobile device.

7. The collection of BrandScanned scanning data via mobile device connection to the interne or some other transmission platform.

8. The collection of BrandScanned code scan data into a database that allows for the connecting of marketers with the customers who use their products and scan the codes.

9. (canceled)

10. (canceled)

11. (canceled)
